(19) United States
(12) Patent Application Publication
(10) Pub. No.: US 2026/0058140 A1
(43) Pub. Date: Feb. 26, 2026

(54) AQUEOUS THICK LITHIUM-ION RECHARGEABLE ELECTRODE AND MANUFACTURING PROCESS

(71) Applicant: Ultralife Corporation, Newark, NY (US)

(72) Inventors: Michael Edward Manna, Canandaigua, NY (US); Xinrong Wang, Fairport, NY (US)

(73) Assignee: Ultralife Corporation, Newark, NY (US)

(21) Appl. No.: 19/071,226

(22) Filed: Mar. 5, 2025

Related U.S. Application Data
(60) Provisional application No. 63/574,540, filed on Apr. 4, 2024.

(51) Int. Cl. H01M 4/583; H01M 4/02; H01M 4/04; H01M 4/133; H01M 4/134; H01M 4/38; H01M 4/62; H01M 4/74

(52) U.S. Cl. CPC H01M 4/583; H01M 4/0404; H01M 4/133; H01M 4/134; H01M 4/386; H01M 4/623; H01M 4/625; H01M 4/74; H01M 2004/021; H01M 2004/027; H01M 2004/028

(57) ABSTRACT

The disclosed method is directed to the manufacture of thick lithium-ion rechargeable battery electrodes, including both anodes and cathodes, with an aqueous process. This thick Li-ion electrode process will form thick electrodes by simultaneously coating materials on both sides of current collectors, using aqueous binder materials, high solid ratios in the range of 70% to 80%, and metal meshes as current collectors instead of metal foils. The electrodes can be formed simultaneously with coating on both sides of metal mesh surfaces instead of coating one side once and then a second time on another side of metal foil surfaces. Water-based and without solvent involved in the process for producing both anodes and cathodes, improves safety, and reduces the cost of equipment and energy for drying electrodes.

This application claims priority under 35 U.S.C. § 119(e) from U.S. Provisional Ser. No. 63/574,540 for an AQUEOUS THICK LITHIUM-ION RECHARGEABLE ELECTRODE AND MANUFACTURING PROCESS, filed Apr. 4, 2024 by Michael Manna and Xinrong Wang, which is hereby incorporated by reference in its entirety.

This disclosure relates to the construction of an aqueous thick lithium-ion rechargeable electrode and a method for the production of such an electrode. The resulting thick electrode is suitable for use in a rechargeable battery.

### BACKGROUND AND SUMMARY

Conventional Li-ion rechargeable electrodes, i.e., anode and cathode, have a total thickness of about 100 μm or less with coating on both sides of a copper or aluminum foil, which act as current collectors. The cathode manufacturing process may be an aqueous process; however, a solvent-based manufacturing process is generally used for cathode creation. A solvent used is N-Methylpyrrolidone (NMP) for PVDF (polyvinylidene fluoride) binder in a cathode slurry mixing and coating process. NMP solvent is not environmentally friendly, is highly flammable, and also needs to be recycled in the manufacturing process.

The conventional Li-ion rechargeable battery electrodes are thin and have the advantage of high-rate capability and good low temperature performance for Li-ion rechargeable batteries. However, the areal active material loading, or areal capacity is low, due to the use of non-active materials such as current collectors and non-active materials such as separators in cell assembly, which have a higher ratio (i.e., a larger proportion of non-active materials in the cell). Increased use of non-active materials leads to lower energy density and higher cost for cells with the same capacity compared to cells using thick electrodes. Furthermore, slurry using the NMP solvent described above has about 30% solids. This means that about 70% liquid in the mixing and coating process needs to be “dried out,” resulting in an extra cost and energy consumption for drying.

As an alternative to a solvent-based process for creation of battery cell electrodes, the disclosed embodiments propose a new manufacturing method to produce thick lithium-ion rechargeable electrodes, including both anode and cathode, with an aqueous process. This thick Li-ion electrode manufacturing process modifies an existing lithium metal primary battery cathode process. Accordingly, the disclosed process uses aqueous binder materials, with a much higher solid ratio, in the range of 70% to 90%, applied to metal meshes that are used as current collectors instead of metal foils. Moreover, the electrodes can be formed simultaneously with coatings being applied on both sides of the metal mesh surfaces instead of coating first on one side or surface of a metal foil and then a second coating on the opposite side or surface of the metal foil.

The aqueous or water-based process further avoids the use of solvent in the process for both anodes and cathodes, improving safety, and reducing the cost of equipment and energy for drying electrodes, and recycling of the NMP or other solvent. The resulting thick electrodes have a thickness range from about 500 μm to 1000 μm which is approximately 5-10 times the thickness of conventional Li-ion rechargeable electrodes. At the same capacity for the cell assembly, the increased electrode thickness means a reduction of 5×-10× for current collector usage compared to conventional Li-ion rechargeable electrodes, which leads to further cost savings on current collectors. This improves the energy processed through production equipment an equitable amount, leading to 5-10× less capital spend and 5-10× smaller factories to produce similar watt hours of finished cells. Furthermore, the energy density for the aqueous thick lithium-ion rechargeable electrodes and battery will increase. Furthermore, there is the same cost saving on separators as well.

The anode electrode active materials may include, but are not limited to, graphite or graphite-silicon composites. The cathode electrode active material may include, but is not limited to, Lithium Nickel Manganese Cobalt oxide (NMC), Lithium Cobalt oxide (LiCoO₂), Lithium Iron Phosphate (LFP), Lithium Manganese Iron Phosphate (LMFP) and others. The conductive agent could be carbon black, graphite, and other forms of carbon materials. The aqueous binder for anode and cathode electrodes may also include, but is not limited to, Polyvinylidene fluoride PVDF, Polytetrafluoroethylen (PTFE), Carboxymethyl cellulose (CMC), Styrene-Butadiene Rubber (SRB) and others with additives. The additives could be organic compounds or inorganic compounds which help to improve uniformity of the mixing and coating operations.

Disclosed in embodiments herein is an electrode suitable for use in a rechargeable battery including: a metal mesh; an anode coating composite coated on both sides of the metal mesh; and a cathode coating composite coated on both sides of the metal mesh; wherein both electrodes have a total thickness range from about 500 μm to 1000 μm. Moreover, the anode coating composite includes an aqueous binder, an anode electrode active material and a conductive agent to produce a mixture having a total solids ratio of at least about 70%, where the total solids of the anode coating composite include the anode electrode active material, conductive material, binder and additive; the cathode coating composite includes aqueous binder, a cathode electrode active material and the conductive agent, to produce a mixture having a total solids ratio of at least about 70%, where total solids of the cathode coating composite include the cathode electrode active material, conductive material, binder and additive; and the anode coating composite, and the cathode coating composite are separately yet simultaneously applied to opposite sides of their own metal mesh using the same coating process to form either an anode or cathode.

Further disclosed in embodiments herein is a method for the production of an electrode suitable for use in a rechargeable battery comprising the steps of: preparing an aqueous anode mix, where adding the aqueous binder includes at least one of Polyvinylidene fluoride (PVDF), Polytetrafluoroethylene (PTFE), Carboxymethyl cellulose (CMC), and Styrene-Butadiene Rubber (SRB); combining (or mixing), with a portion of the aqueous binder, adding an anode electrode active material and a conductive agent, and adding other liquid and additives, then using a mixer to produce the uniform anode coating composite having a total solids ratio of at least about 70%, where the total solids of the anode coating include anode electrode active material, conductive material, binder and an additive(s); combining (or mixing), simultaneously applying the anode coating composite to both sides of a metal mesh such as copper mesh or stainless steel mesh.

Further disclosed in embodiments herein is a method for the production of an electrode suitable for use in a rechargeable battery comprising the steps of: preparing an aqueous cathode mix, where adding the aqueous binder includes at least one of Polyvinylidene fluoride (PVDF), Polytetrafluoroethylene (PTFE), Carboxymethyl cellulose (CMC), and Styrene-Butadiene Rubber (SRB); combining (or mixing), with a portion of the aqueous binder, adding a cathode electrode active material and a conductive agent, and adding other liquid and additives, then using a mixer to produce the uniform cathode coating composite having a total solids ratio of at least about 70%, where the total solids of the cathode coating include cathode electrode active material, conductive material, binder and an additive(s); combining (or mixing), simultaneously applying the cathode coating composite two sides of a metal mesh such as aluminum mesh.

### BRIEF DESCRIPTION OF THE DRAWINGS

FIGS. 1A and 1B are general cross-sectional illustrations of two (anode and cathode, respectively) thick lithium-ion rechargeable electrodes;

FIG. 2 is a schematic illustration of the mixing process by which aqueous lithium-ion rechargeable electrode mixtures are produced for coating thick lithium-ion rechargeable electrodes; and

FIG. 3 is a schematic illustration of the formation process by which aqueous thick lithium-ion rechargeable electrodes are produced in accordance with the disclosed embodiment.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

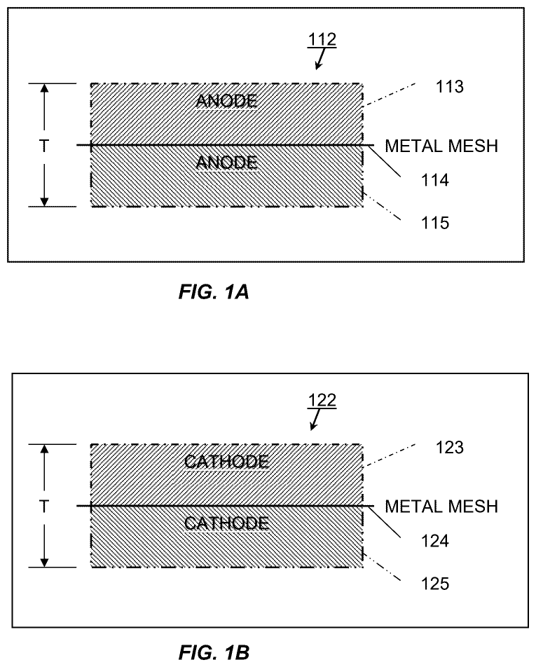

Referring to the figures, in FIG. 1 an electrode suitable for use in a rechargeable battery is depicted. The anode electrode 112 includes a metal mesh 114, sandwiched between an anode coating composite 113 coated on one side of the metal mesh and an anode coating composite 115 coated on an opposite side of the metal mesh. The metal mesh for anode could be copper mesh, or stainless-steel mesh and others. The electrode 112 has a total thickness (T) in range from about 500 μm to 1000 μm. The anode coating composite 112 includes an aqueous binder, an anode electrode active material and a conductive agent to produce a mixture having a total solids ratio of at least about 70%, where the total solids of the anode coating composite include the anode electrode active material, conductive material, binder and additive. The cathode electrode 122 includes a metal mesh 124, sandwiched between a cathode coating composite 123 coated on one side of the metal mesh and a cathode coating composite 125 coated on an opposite side of the metal mesh. The metal mesh for cathode could be aluminum mesh, or stainless-steel mesh and others. The electrode 122 has a total thickness (T) in range from about 500 μm to 1000 μm. The cathode coating composite 122 includes an aqueous binder, a cathode electrode active material and a conductive agent to produce a mixture having a total solids ratio of at least about 70%, where the total solids of the cathode coating composite include the cathode electrode active material, conductive material, binder and additive. Both the anode coating composite and the cathode coating composite may be simultaneously applied to two sides of the metal mesh during fabrication of the respective anode or cathode electrodes.

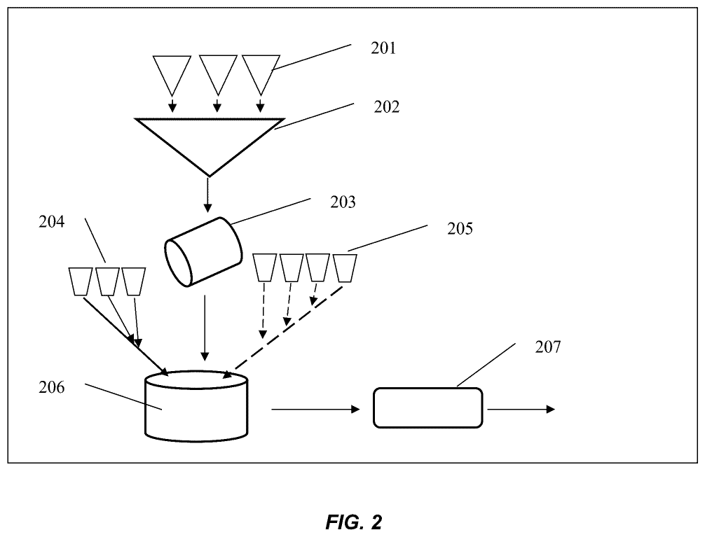

A schematic illustration of the mixing process or method for production of the electrodes of FIGS. 1A and 1B is presented in FIG. 2. The method comprises the steps of delivering raw powder materials 201, weighing raw materials regarding formulations into hub 202, then deliver them into a dry powder mixer 203; dry powder, after being well mixed will be delivered into wet mixer 206; DI-water and additional liquid agents 204 will be added into the wet mixer 206 per formulation, mix the liquid and dry powder, then add water-based binder, additional additives 205 into wet mixer and then mix for a certain time. At 205, one of the additives is the aqueous binder, a mixture including at least one of Polyvinylidene fluoride (PVDF), Polytetrafluoroethylene (PTFE), Carboxymethyl cellulose (CMC), and Styrene-Butadiene Rubber (SRB). Next, in vessel 206, a portion of the aqueous binder is combined or mixed with an anode electrode active material and a conductive agent to produce an anode or cathode coating composite having a total solids ratio of at least about 70%, where the total solids of the anode coating include electrode active material, conductive material, binder and an additive(s). The finished mix from mixing vessel 206 will be transferred to a machine 207 to form granular shape which is ready for coating.

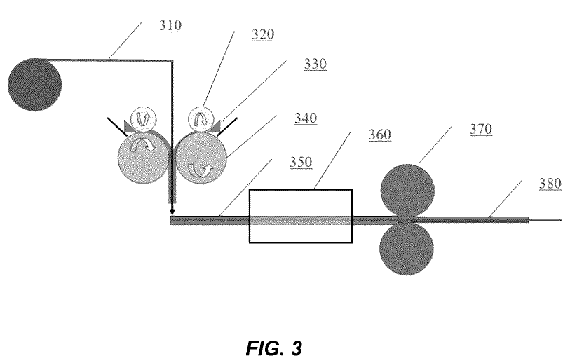

A schematic illustration of the formation process or method for production of the electrode of FIGS. 1A and 1B is presented in FIG. 3. The method comprises the steps of pulling a metal mesh 310 from a roll format into a coating head 340, adding granular mix from 207 into coating hubs 330, then the granular mix goes through gaps between metering rolls 320 (which meter the amount of the granular mix to be applied) and embed rolls 340 to then join with the metal mesh 310 and coating on both sides of the metal mesh simultaneously at embed rolls gaps. Then the coated mesh 350 is delivered into dryer 360, which dries the electrode assembly by using hot air or other drying methods to dry out de-ionized water (DI-water) and other liquid, then dried electrode 350 is pressed under two calendaring rolls 370 to densify and get the finished electrode 380 with a designed thickness and density.

The same formation process can be conducted for both electrodes, anode or cathode, separately as described relative to FIG. 3, with the difference being the anode current collector, i.e. anode metal mesh and anode composite, or the cathode current collector, i.e. cathode metal mesh and cathode composite.

### EXAMPLE(S)

The following examples are provided as illustrations and should not be interpreted as constituting any limitation of the invention.

Example 1: In one embodiment, fabrication of electrode samples was carried out as follows: Anode powder components of active material MCMB graphite (95-98%), conductive agent materials carbon black (1-3%) and KS6 graphite (0.2-1%) are dry mixed to become a uniform mix. Then add DI-water (15-20% of total wet mix) with dispersion additives (one of inorganic compounds such as carbon nano-tube, grapherene, SiO₂, Al₂O₃, B₂O₃, TiO₂, and ZnO₂) (0.1-8% of total wet mix) into dry powder, wet mix them for few minutes, then add water-based binder material (one of Polyvinylidene fluoride (PVDF), Polytetrafluoroethylene (PTFE), Carboxymethyl cellulose (CMC), and Styrene-Butadiene Rubber (SRB)) (1-6% of total wet mix), and additive (one of organic compounds or substances such as vinegar, wine, honey, sugar, polymer, starch, flour) (0.1-1% of total wet mix), mix them again. The mix is then put through a grinder machine to make assorted granules in the 0.01 mm to 6 mm in range.

Above, the anode mix granules are used at the coating line with gap settings to coat the thick electrode simultaneously on both sides of the metal mesh which is the current collector. Then the coated anode goes through the drying oven to dry out water and liquid components, followed by a pass through the calendaring rolls for densifying the anode to a desired final thickness and density.

Example 2: In another example embodiment, fabrication of electrode samples was carried out as follows: Cathode powder components of active material LiFePO₄ (LFP) (94-98%), conductive agent materials carbon black (1-4%) and KS6 graphite (0.2-1%) are dry mixed to become a uniform mix. Then add DI-water (13-20% of total wet mix) with dispersion additives (one of inorganic compounds such as carbon nano-tube, grapherene, SiO₂, Al₂O₃, B₂O₃, TiO₂, and ZnO₂) (0.1-6% of total wet mix) into dry powder, wet mix them for few minutes, then add water-based binder material (one of Polyvinylidene fluoride (PVDF), Polytetrafluoroethylene (PTFE), Carboxymethyl cellulose (CMC), and Styrene-Butadiene Rubber (SRB)) (1-8% of total wet mix), and addictive (one of organic compounds or substances such as vinegar, wine, honey, sugar, polymer, starch, flour) (0.1-1% of total wet mix), mix them again. The mix is then put through a grinder machine to make assorted granules in the 0.01 mm to 6 mm in range.

Above, the cathode mix granules are used at the coating line with gap settings to coat the thick electrode simultaneously on both sides of the metal mesh which is the current collector. Then the coated cathode goes through the drying oven to dry out water and liquid components, followed by a pass through calendaring rolls for densifying the cathode to a desired final thickness and density.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

1. An electrode suitable for use in a rechargeable battery including:
a metal mesh;
a coating composite, suitable for use either as an anode or as a cathode, the coating composite coated on two opposite sides of the metal mesh;
wherein the electrode has a total thickness range from 500 μm to 1000 μm.

2. The electrode according to claim 1, wherein the coating composite is an anode coating composite including an aqueous binder, an anode electrode active material and a conductive agent to produce a mixture having a total solids ratio of at least 70%, where the total solids of the anode coating composite include the anode electrode active material, conductive material, binder and additive.

3. The electrode according to claim 2, wherein the anode coating composite is simultaneously applied to opposite sides of the metal mesh during fabrication to form an anode electrode.

4. The electrode according to claim 1, wherein the coating composite is a cathode coating composite including aqueous binder, a cathode electrode active material and the conductive agent, to produce a mixture having a total solids ratio of at least 70%, where total solids of the cathode coating composite include the cathode electrode active material, conductive material, binder and additive.

5. The electrode according to claim 4, wherein the cathode coating composite is simultaneously applied to opposite sides of the metal mesh during fabrication to form a cathode electrode.

6. A method for the production of an electrode suitable for use in a rechargeable battery comprising the steps of:
preparing an aqueous binder, where the aqueous binder includes at least one of Polyvinylidene fluoride (PVDF), Polytetrafluoroethylene (PTFE), Carboxymethyl cellulose (CMC), and Styrene-Butadiene Rubber (SRB);
combining, with a portion of the aqueous binder, an anode electrode active material and a conductive agent to produce an anode coating composite having a total solids ratio of at least 70%, where the total solids of the anode coating include anode electrode active material, conductive material, binder and an additive;
combining, with a portion of the aqueous binder, a cathode electrode active material and the conductive agent, to produce a cathode coating composite having a total solids ratio of at least 70%, where total solids of the cathode coating include cathode electrode active material, conductive material, binder and an additive;
simultaneously applying the anode coating composite to opposite sides of a first metal mesh;
simultaneously applying the cathode coating composite to opposite sides of a second metal mesh; and
allowing the coated first metal mesh and the coated second metal mesh to dry and form, respectively, an anode electrode and a cathode electrode.

7. The method according to claim 6, wherein preparing the aqueous binder includes mixing an additive to improve uniformity of the aqueous binder.

8. The method according to claim 6 wherein the anode electrode active material is selected from the group consisting of graphite and graphite-silicon composites.

9. The method according to claim 6 wherein the conductive agent is selected from the group consisting of carbon black, graphite, and other carbon-based materials.

10. The method according to claim 6, wherein the total solids ratio for at least one of the anode coating composite and the cathode coating composite is between 70% and 80%.

11. The method according to claim 6, where the resulting anode electrode and the resulting cathode electrode each has a total thickness range between 500 μm to 1000 μm.

12. An electrode produced according to the method of claim 6.
